(19) United States
(12) Patent Application Publication
(10) Pub. No.: US 2015/0093568 A1
(43) Pub. Date: Apr. 2, 2015

(54) WINDOW PANEL FOR DISPLAY DEVICE AND DISPLAY DEVICE INCLUDING THE SAME

(71) Applicant: Samsung Display Co., Ltd., Yongin-city (KR)

(72) Inventors: Hun Kyo Kim, Cheonan-si (KR); Ju Suk Oh, Cheonan-si (KR); Sang Gu Kim, Seoul (KR); Hyoung Suk Roh, Cheonan-si (KR)

(73) Assignee: Samsung Display Co., Ltd., Yongin-city (KR)

(21) Appl. No.: 14/244,664

(22) Filed: Apr. 3, 2014

(30) Foreign Application Priority Data
Sep. 27, 2013 (KR) 10-2013-0115347

(51) Int. Cl. C08K 5/3417; C09D 163/00; C09D 133/00

(52) U.S. Cl. CPC C08K 5/3417; C09D 133/00; C09D 163/00
USPC 428/336; 428/473.5

(57) ABSTRACT

In an aspect, a window panel for a display device includes a plastic substrate formed of a transparent polyimide, and a first colored hard coating layer disposed at one surface of the plastic substrate is provided.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0115347 filed in the Korean Intellectual Property Office on Sep. 27, 2013, the disclosure of which is incorporated herein by reference in its entirety.

### BACKGROUND

1. Field

This disclosure relates to a window panel for a display device and a display device including the same. For example, the present disclosure relates to a window panel for a display device protecting against high temperature and humidity and a display device including the same.

2. Description of the Related Technology

Typical display devices are a liquid crystal display (LCD), a plasma display device (PDP), an organic light emitting diode (OLED) display, an electric field effect display (FED), and an electrophoretic display device.

The display devices includes a window panel to protect an inner module from external heat, moisture, and impact. The window panel may be formed of glass, however glass may be broken by external impact such that it is inappropriate include it in a portable device such as a mobile phone.

Thus, research on a plastic material to form the window panel instead of glass has been investigated. PMMA (polymethyl methacrylate), PC (polycarbonate), PET (polyethylene terephthalate), etc. have been developed as plastic materials for window panel of display devices. The plastic material may have desirable characteristics such as appropriate hardness and appropriate impact resistance, however a curl may be generated in the window panel in a high temperature and high humidity environment.

The above information disclosed in this Background section is only for enhancement of understanding of the background of the disclosure and therefore it may contain information that does not form the prior art that is already known to a person of ordinary skill in the art.

### SUMMARY

Embodiments of the present disclosure provide a window panel for a display device protecting against a high temperature and high humidity environment and a display device including the same.

Some embodiments provide a window panel for a display device including a plastic substrate formed of a transparent polyimide, and a first colored hard coating layer disposed at one surface of the plastic substrate.

In some embodiments, a second colored hard coating layer disposed at another surface of the plastic substrate may be further included in the window panel.

In some embodiments, at least one of the first colored hard coating layer and the second colored hard coating layer may include a blue pigment.

In some embodiments, the blue pigment may include a metal phthalocyanine complex, wherein the phthalocyanine is optionally substituted with one or more halogens. In some embodiments, the metal phthalocyanine complex may be a copper phthalocyanine complex, wherein the phthalocyanine is optionally substituted with one or more halogens. In some embodiments, the copper phthalocyanine complex may be HELIOGEN blue (commercially available from BASF, Ludwigshafen, Germany). In some embodiments, the copper phthalocyanine complex may be HELIOGEN Blue L 6700 F, HELIOGEN Blue L 6870, HELIOGEN Blue L 6875 F, HELIOGEN Blue L 6900, HELIOGEN Blue L 6901 F, HELIOGEN Blue L 6905 F, HELIOGEN Blue L 6920, HELIOGEN Blue L 6930, HELIOGEN Blue L 6975 F, HELIOGEN, Blue L 6989 F, HELIOGEN Blue L 6990 F, HELIOGEN Blue L 7072 D, HELIOGEN Blue L 7080, HELIOGEN Blue L 7081 D, HELIOGEN Blue L 7085 D, HELIOGEN Blue L 7101 F, HELIOGEN Blue L 7460 (commercially available from BASF, Ludwigshafen, Germany).

In some embodiments, the polymer solution to form at least of one of the first colored hard coating layer and the second colored hard coating layer may include the HELIOGEN blue at about 10%.

In some embodiments, the polymer solution to form at least of one of the first colored hard coating layer and the second colored hard coating layer may include the HELIOGEN blue at about 5%.

In some embodiments, at least of one of the first colored hard coating layer and the second colored hard coating layer may be formed with a thickness of 20 μm. In some embodiments, at least of one of the first colored hard coating layer and the second colored hard coating layer may be formed with a thickness in the range of from about 10 μm to about 30 μm. In some embodiments, at least of one of the first colored hard coating layer and the second colored hard coating layer may be formed with a thickness in the range of from about 15 μm to about 25 μm.

In some embodiments, a yellow index may be less than 1 by the first colored hard coating layer and the second colored hard coating layer.

In some embodiments, a display device according to another exemplary embodiment of the present invention includes: a display module including a plurality of display elements; and a first window panel disposed at one surface of the display module, wherein the first window panel includes a plastic substrate formed of a transparent polyimide; and a first colored hard coating layer disposed at one surface of the plastic substrate.

In some embodiments, the first window panel may further include a second colored hard coating layer disposed at the other surface of the plastic substrate.

In some embodiments, at least one of the first colored hard coating layer and the second colored hard coating layer may include a blue pigment.

In some embodiments, the blue pigment may include HELIOGEN blue.

In some embodiments, the polymer solution to form at least of one of the first colored hard coating layer and the second colored hard coating layer may include the HELIOGEN blue at about 10%.

In some embodiments, the polymer solution to form at least of one of the first colored hard coating layer and the second colored hard coating layer may include the HELIOGEN blue at about 5%.

In some embodiments, at least one of the first colored hard coating layer and the second colored hard coating layer may be formed with a thickness of 20 μm. In some embodiments, at least of one of the first colored hard coating layer and the second colored hard coating layer may be formed with a thickness in the range of from about 10 μm to about 30 μm. In some embodiments, at least of one of the first colored hard coating layer and the second colored hard coating layer may be formed with a thickness in the range of from about 15 μm to about 25 μm.

In some embodiments, a second window panel disposed at the other surface of the display module may be further included, and the second window panel may be formed with the same as the first window panel.

In some embodiments, a second window panel disposed at the other surface of the display module may be further included, and the second window panel may be formed with the same as the first window panel.

In some embodiments, the second window panel may further include a second colored hard coating layer disposed at the other surface of the plastic substrate included in the second window panel.

In some embodiments, the window panel for the display device having strength against a high temperature and high humidity environment may be provided by using a polyimide.

Further, by using the polyimide as the window panel for the display device, the deterioration of the photo-characteristic may be resolved by the unique characteristic of the polyimide having the high yellow index, and surface hardness of the window panel for the display device may be obtained.

### BRIEF DESCRIPTION OF THE DRAWINGS

FIG. 1 is a cross-sectional view of a display device according to an exemplary embodiment.

FIG. 2 is a cross-sectional view of a window panel for a display device according to an exemplary embodiment.

FIG. 3 is a cross-sectional view of a window panel for a display device according to another exemplary embodiment.

FIG. 4 is a cross-sectional view of a window panel for a display device according to another exemplary embodiment.

FIG. 5 is a cross-sectional view of a window panel for a display device according to another exemplary embodiment.

FIG. 6 is a cross-sectional view of a display device according to another exemplary embodiment.

### DETAILED DESCRIPTION

In the following detailed description, only certain exemplary embodiments of the present disclosure have been shown and described, simply by way of illustration. As those skilled in the art would realize, the described embodiments may be modified in various different ways, all without departing from the spirit or scope of the present embodiments.

In a variety of exemplary embodiments, constituent elements having the same structure will be representatively described in a first exemplary embodiment, through like reference numerals. In the other exemplary embodiments, the descriptions thereof will be focused on different constituent elements from those of the first exemplary embodiment.

In order to clearly describe the present embodiments, parts unrelated to the descriptions will be omitted. Throughout the disclosure, like reference numerals refer to like or similar constituent elements.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

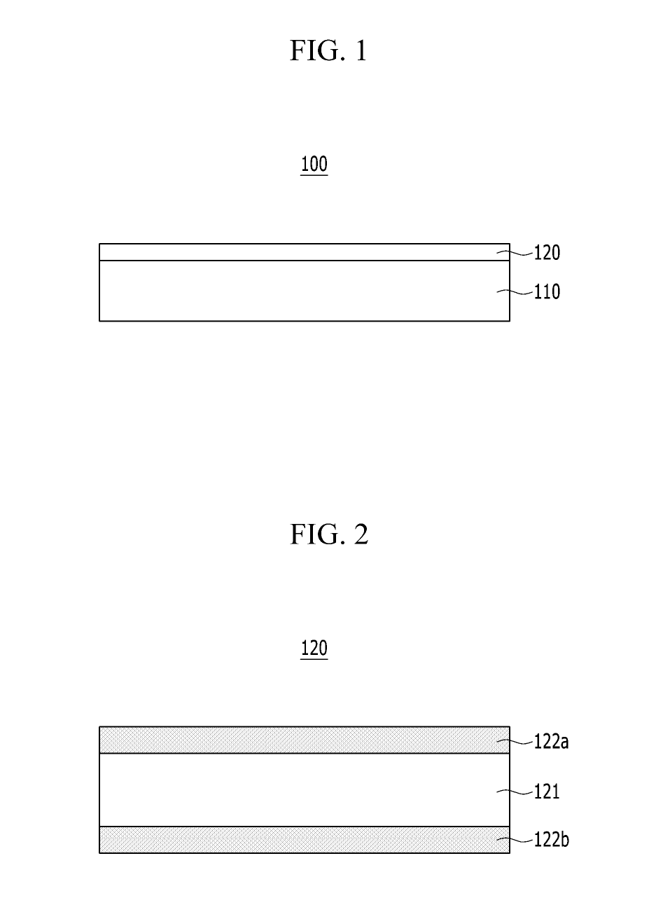

FIG. 1 is a cross-sectional view of a display device according to an exemplary embodiment.

Referring to FIG. 1, a display device 100 includes a display module 110 displaying an image and a window panel 120 to protect the display module 110.

In some embodiments, the display module 110 includes a plurality of display elements. In some embodiments, the plurality of display elements may be one among display elements such as a liquid crystal display (LCD), a plasma display panel (PDP), an organic light emitting display (OLED), a field effect display (FED), and an electrophoretic display. In some embodiments, the display module 110 may be one display module among the liquid crystal display, the plasma display device, the organic light emitting device, the electric field effect display device, and the electrophoretic display.

In some embodiments, the window panel 120 is disposed on one surface of the display module 110. In some embodiments, the window panel 120 may be adhered to one surface of the display module 110 by using an adhesive. In some embodiments, the window panel 120 is only adhered to one surface of the display module 110, however the window panel 120 may be adhered to both surfaces of the display module 110.

Next, various constitutions of the window panel 120 will be described with reference to FIGS. 2 to 5.

FIG. 2 is a cross-sectional view of a window panel for a display device according to an exemplary embodiment.

Referring to FIG. 2, the window panel 120 according to the first exemplary embodiment includes a plastic substrate 121, a first colored hard coating layer 122a disposed at one surface of the plastic substrate 121, and a second colored hard coating layer 122b disposed at the other surface of the plastic substrate 121.

In some embodiments, the plastic substrate 121 may be made of a transparent polyimide (PI). As the plastic substrate 121, PMMA (polymethyl methacrylate), PC (polycarbonate), or PET (polyethylene terephthalate) may be used, however the PMMA, PC, and PET may have a drawback that a curl may be generated in a high temperature and high humidity environment. In contrast, PI has good thermal resistance and strength against the high temperature and high humidity environment.

In some embodiments, the first colored hard coating layer 122a and the second colored hard coating layer 122b may include one of an organic compound and an organic/inorganic composite compound, and a blue pigment. For example, the organic compound may include an acryl-based compound, an epoxy-based compound, or a combination thereof. In some embodiments, the organic/inorganic composite compound may include a silicon compound such as polysilsesquioxane. The blue pigment may include HELIOGEN blue. In some embodiments, the blue pigment may be Prussian blue or phthalocyanine blue.

In some embodiments, the first colored hard coating layer 122a and the second colored hard coating layer 122b include the blue pigment, however the first colored hard coating layer 122a and the second colored hard coating layer 122b may include other pigments as well as the blue pigment.

Some embodiments include a process of forming the window panel 120 as follows.

A plastic substrate 121 made of a transparent polyimide may be dipped in a polymer solution mixed with one of the organic compound and the organic/inorganic compound to be coated, and is dried to form a window panel 120. Here, the polymer solution may include HELIOGEN blue at 10%. In some embodiments, the polymer solution may include HELIOGEN blue at 5%.

In some embodiments, the first colored hard coating layer 122a and the second colored hard coating layer 122b may be respectively formed with a thickness of 20 μm. In some embodiments, at least of one of the first colored hard coating layer and the second colored hard coating layer may be formed with a thickness in the range of from about 10 μm to about 30 μm. In some embodiments, at least of one of the first colored hard coating layer and the second colored hard coating layer may be formed with a thickness in the range of from about 15 μm to about 25 μm. In some embodiments, the plastic substrate 121 may be provided with a thickness of 0.66 mm, and the window panel 120 may be formed with a thickness of 0.7 mm. In some embodiments, the window panel may be formed with a thickness in the range of from about 0.6 mm to about 0.6 mm. In some embodiments, the window panel may be formed with a thickness in the range of from about 0.68 mm to about 0.72 mm.

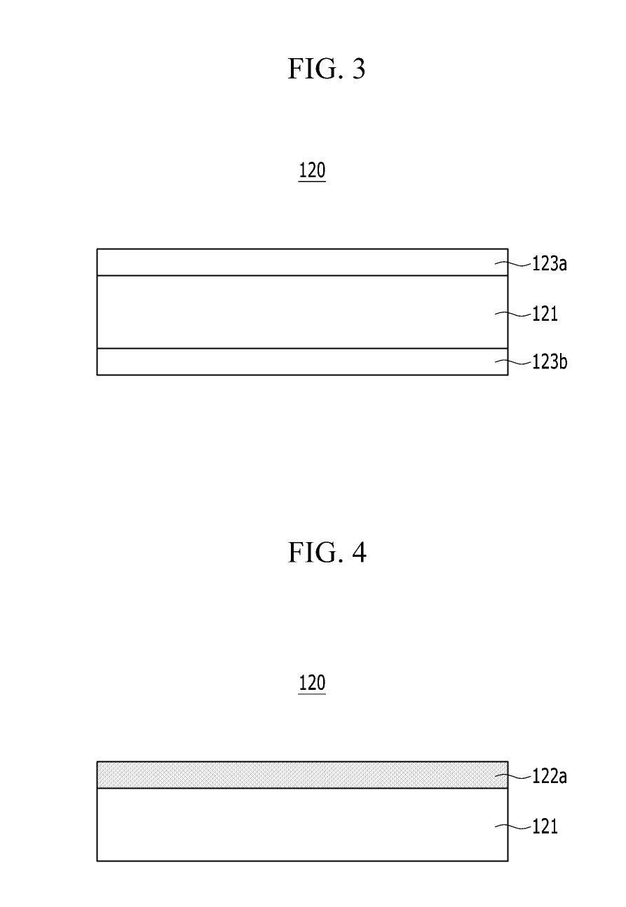

FIG. 3 is a cross-sectional view of a window panel for a display device according to another exemplary embodiment of the present invention.

Referring to FIG. 3, a window panel 120 according to a second exemplary embodiment includes a plastic substrate 121, a first colorless hard coating layer 123a disposed at one surface of the plastic substrate 121, and a second colorless hard coating layer 123b disposed at the other surface of the plastic substrate 121.

As a difference from FIG. 2, the first colorless hard coating layer 123a and the second colorless hard coating layer 123b do not include the pigment, and one of the organic compound and the organic/inorganic compound is included. The plastic substrate 121 made of the transparent polyimide is dipped in the polymer solution without the pigment to be coated, and is dried to form the window panel 120.

FIG. 4 is a cross-sectional view of a window panel for a display device according to another exemplary embodiment of the present invention.

Referring to FIG. 4, a window panel 120 according to a third exemplary embodiment includes a plastic substrate 121 and a first colored hard coating layer 122a disposed at one surface of the plastic substrate 121.

As a difference from FIG. 2, the second colored hard coating layer 122b is omitted. In some embodiments, after forming a protection film or a passivation layer at the other surface of the plastic substrate 121, the plastic substrate 121 may be dipped in the polymer solution including the pigment to be coated. In some embodiments, after the coating, the protection film or the passivation layer formed at the other surface of the plastic substrate 121 may be removed to only form the first colored hard coating layer 122a at one surface of the plastic substrate 121.

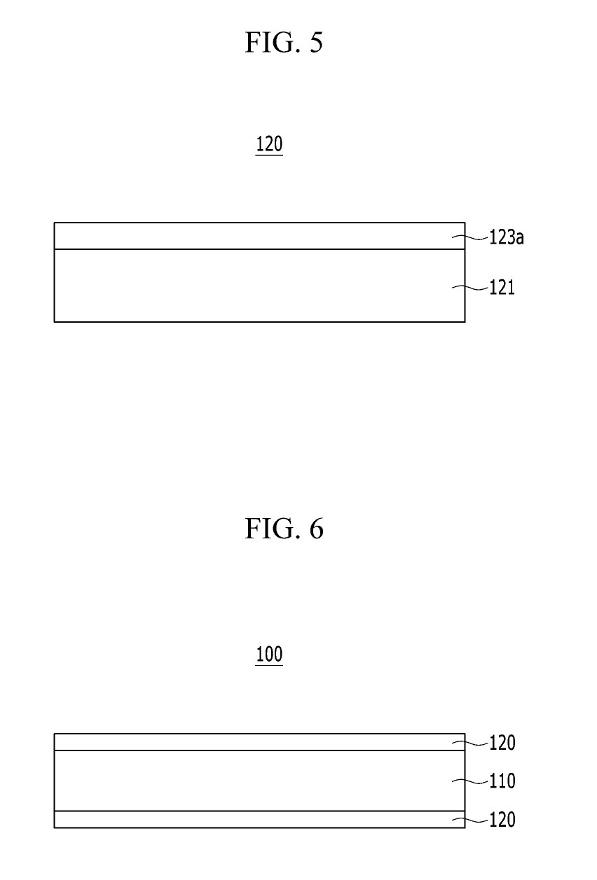

FIG. 5 is a cross-sectional view of a window panel for a display device according to another exemplary embodiment of the present invention.

Referring to FIG. 5, a window panel 120 according to a fourth exemplary embodiment includes a plastic substrate 121 and a first colorless hard coating layer 123a disposed at one surface of the plastic substrate 121.

As a difference from FIG. 3, the second colorless hard coating layer 123b is omitted. In some embodiments, after forming a protection film or a passivation layer at the other surface of the plastic substrate 121, the plastic substrate 121 may be dipped in the polymer solution without the pigment to be coated. In some embodiments, after the coating, the protection film or the passivation layer formed at the other surface of the plastic substrate 121 may be removed to only form the first colorless hard coating layer 123a at one surface of the plastic substrate 121.

Next, a result of experimentation with transmittance, yellow index (YI), haze, surface hardness, and curl of the window panel 120 according to the first to third exemplary embodiments will be described with reference to Table 1.

In the window panel 120 according to the first exemplary embodiment, the thickness of the plastic substrate 121 is 0.66 mm and each thickness of the first colored hard coating layer 122a and the second colored hard coating layer 122b is 20 μm. The entire thickness of the window panel 120 of the first exemplary embodiment is 0.7 mm. The polymer solution to form the first colored hard coating layer 122a and the second colored hard coating layer 122b includes HELIOGEN blue at 10% (HELIOGEN blue, BASF, Ludwigshafen, Germany). According to the first exemplary embodiment, a plurality of samples are provided, three samples are randomly selected among the plurality of samples, the transmittance, the yellow index, the haze, the surface hardness, and the curl generation are measured, and each average is calculated.

In the window panel 120 according to the second exemplary embodiment, the thickness of the plastic substrate 121 is 0.66 mm, and each thickness of the first colorless hard coating layer 123a and the second colorless hard coating layer 123b is 20 μm. The entire thickness of the window panel 120 of the second exemplary embodiment is 0.7 mm. The polymer solution used to form the first colorless hard coating layer 123a and the second colorless hard coating layer 123b does not include the pigment. According to the second exemplary embodiment, a plurality of samples are provided, three samples are randomly selected among the plurality of samples, the transmittance, the yellow index, the haze, the surface hardness, and the curl generation are measured, and each average is calculated.

In the window panel 120 according to the third exemplary embodiment, the thickness of the plastic substrate 121 is 0.68 mm and the thickness of the first colored hard coating layer 122a is 20 μm. The entire thickness of the window panel 120 of the third exemplary embodiment is 0.7 mm. The polymer solution to form the first colored hard coating layer 122a includes HELIOGEN blue at 5% (HELIOGEN blue, BASF, Ludwigshafen, Germany). According to the third exemplary embodiment, a plurality of samples are provided, three samples are randomly selected among the plurality of samples, the transmittance, the yellow index, the haze, the surface hardness, and the curl generation are measured, and each average is calculated.

Table 1 shows the experimental result of the transmittance, the yellow index (YI), the haze, the surface hardness, and the curl generation of the window panel 120 according to the first to third exemplary embodiments.

TABLE 1

| | Trans- | | | Surface | Curl |
|---|---|---|---|---|---|
| | mittance | YI | Haze | hardness | generation |
| First exemplary | 89.2% | 0.74 | 0.4 | 8H | No |
| embodiment | | | | | |
| Second exemplary | 89.8% | 1.93 | 0.4 | 8H | No |
| embodiment | | | | | |
| Third exemplary | 90.2% | 2.39 | 0.3 | 8H | 0.15 |
| embodiment | | | | | |

In the first to third exemplary embodiments, the transmittance, the haze, and the surface hardness have no large difference, however the yellow index (YI) of the window panel 120 according to the first exemplary embodiment is lowest at 0.74, the yellow index (YI) of the window panel 120 according to the second exemplary embodiment is high at 1.93, and the yellow index (YI) of the window panel 120 according to the third exemplary embodiment is highest at 2.39.

The polyimide has high thermal resistance thereby having strength against the high temperature and high humidity environment, while in contrast, the yellow index (YI) is high at 2.4 such that there is a drawback that a photo-characteristic of the display device is deteriorated. However, by disposing the first colored hard coating layer 122a and the second colored hard coating layer 122b at both surfaces of the polyimide in the manner of the window panel 120 according to the first exemplary embodiment, the yellow index (YI) may be decreased to 0.74 such that deterioration of the photo-characteristic may be resolved by a unique characteristic of the polyimide. That is, in the window panel 120 according to the first exemplary embodiment, a yellow index (YI) of less than 1 is obtained by the first colored hard coating layer 122a and the second colored hard coating layer 122b.

Also, for the window panel 120 according to the third exemplary embodiment disposing the hard coating layer at one surface, the flatness is changed to 0.15 in the experiment of the curl generation, however, for the window panel 120 according to the first and second exemplary embodiments when disposing the hard coating layer at both surfaces, the curl is not generated. The curl generation experiment is performed by a method in which the sample is inserted in a chamber at a temperature of 85° C. and humidity of 85%, and a degree that the flatness is changed is measured after 120 hours.

The surface hardness of the window panel 120 is measured by using a pencil hardness tester. When the hard coating layer is less than 5 μm, the surface hardness is less than 4H, however, like the first to third exemplary embodiments, the surface hardness is 8H when the hard coating layer is 20 μm thick.

As a result, the window panel 120 according to the first exemplary embodiment is not only strong against the high temperature and high humidity environment, but it may solve the photo-characteristic deterioration by the unique characteristic of the polyimide. In some embodiments, the window panel 120 according to the second exemplary embodiment is strong against the high temperature and high humidity environment, however the yellow index (YI) is slightly high. In some embodiments, the window panel 120 according to the third exemplary embodiment may somehow decrease the yellow index (YI), however the curl is slightly generated at the other surface on which the hard coating layer is not formed. Also, the window panel 120 according to the first to third exemplary embodiments may have improved surface hardness.

In the above, it is assumed that the window panel 120 is adhered to one surface of the display module 110. In some embodiments, the window panel 120 may be adhered to both surfaces of the display module 110, and this will be described with reference to FIG. 6.

FIG. 6 is a cross-sectional view of a display device according to another exemplary embodiment of the present invention.

Referring to FIG. 6, the display device 100 includes a display module 110 and window panels 120 disposed at both surfaces of the display module 110.

In some embodiments, one window panel 120 disposed at one surface of the display module 110 may be the window panel 120 according to the first to fourth exemplary embodiments shown in FIGS. 2 to 5. Further, the other window panel 120 disposed at the other surface of the display module 110 may be the window panel 120 according to the first to fourth exemplary embodiments shown in FIGS. 2 to 5.

In some embodiments, the window panels 120 disposed at both surfaces of the display module 110 may be appropriately selected among the window panels 120 according to the first to fourth exemplary embodiments.

While this invention has been described in connection with what is presently considered to be practical exemplary embodiments, it is to be understood that the invention is not limited to the disclosed embodiments and is intended to cover various modifications and equivalent arrangements included within the spirit and scope of the appended claims. Therefore, those skilled in the art will understand that various modifications and other equivalent exemplary embodiments may be possible. Accordingly, the actual technical protection scope of the present embodiments as defined by the following claims.

What is claimed is:

1. A window panel for a display device comprising:
a plastic substrate formed of a transparent polyimide; and
a first colored hard coating layer disposed at one surface of the plastic substrate.

2. The window panel of claim 1, further comprising
a second colored hard coating layer disposed at another surface of the plastic substrate.

3. The window panel of claim 2, wherein
at least one of the first colored hard coating layer and the second colored hard coating layer includes a blue pigment.

4. The window panel of claim 3, wherein
the blue pigment includes a metal phthalocyanine complex, wherein the phthalocyanine is optionally substituted with one or more halogens.

5. The window panel of claim 4, wherein
the polymer solution to form at least of one of the first colored hard coating layer and the second colored hard coating layer includes the metal phthalocyanine complex at about 10%, wherein the phthalocyanine is optionally substituted with one or more halogens.

6. The window panel of claim 4, wherein
the polymer solution to form at least of one of the first colored hard coating layer and the second colored hard coating layer includes the metal phthalocyanine complex at about 5%, wherein the phthalocyanine is optionally substituted with one or more halogens.

7. The window panel of claim 2, wherein
at least of one of the first colored hard coating layer and the second colored hard coating layer is formed with a thickness of 20 μm.

8. The window panel of claim 2, wherein
a yellow index is less than 1 by the first colored hard coating layer and the second colored hard coating layer.

9. A display device comprising:
a display module including a plurality of display elements; and
a first window panel disposed at one surface of the display module,
wherein the first window panel includes
a plastic substrate formed of a transparent polyimide, and
a first colored hard coating layer disposed at one surface of the plastic substrate.

10. The display device of claim 9, wherein
the first window panel further includes
a second colored hard coating layer disposed at the other surface of the plastic substrate.

11. The display device of claim 10, wherein
at least one of the first colored hard coating layer and the second colored hard coating layer includes a blue pigment.

12. The display device of claim 11, wherein
the blue pigment includes a metal phthalocyanine complex, wherein the phthalocyanine is optionally substituted with one or more halogens.

13. The display device of claim 12, wherein
the polymer solution to form at least of one of the first colored hard coating layer and the second colored hard coating layer includes the a metal phthalocyanine complex at about 10%, wherein the phthalocyanine is optionally substituted with one or more halogens.

14. The display device of claim 12, wherein
the polymer solution to form at least of one of the first colored hard coating layer and the second colored hard coating layer includes the a metal phthalocyanine complex at about 5%, wherein the phthalocyanine is optionally substituted with one or more halogens.

15. The display device of claim 10, wherein
at least of one of the first colored hard coating layer and the second colored hard coating layer is formed with a thickness of 20 μm.

16. The display device of claim 10, further comprising
a second window panel disposed at the other surface of the display module,
wherein the second window panel is formed the same as the first window panel.

17. The display device of claim 9, further comprising
a second window panel disposed at the other surface of the display module,
wherein the second window panel is formed the same as the first window panel.

18. The display device of claim 17, wherein
the second window panel further includes
a second colored hard coating layer disposed at the other surface of the plastic substrate included in the second window panel.

19. The display device of claim 4, wherein the metal phthalocyanine complex is HELIOGEN blue.

20. The display device of claim 12, wherein the metal phthalocyanine complex is HELIOGEN blue.
